(19) United States
(12) Patent Application Publication
(10) Pub. No.: US 2019/0392054 A1
(43) Pub. Date: Dec. 26, 2019

(54) SYSTEM AND METHOD FOR PRE-FETCHING MAP DATA

(71) Applicant: Uber Technologies, Inc., San Francisco, CA (US)

(72) Inventors: Mathieu Courtemanche, Berkeley, CA (US); Henry Martin Dooley, San Francisco, CA (US); Vincent Dumont, San Francisco, CA (US); Matthew Richard Matheson, San Francisco, CA (US); Johnathan Daniel Lansing, Westminster, CO (US)

(21) Appl. No.: 16/013,206

(22) Filed: Jun. 20, 2018

(51) Int. Cl. G06F 17/30; G01C 21/34; H04L 12/24; H04W 4/021; G08G 1/0968

(52) U.S. Cl. CPC G06F 17/30241; G01C 21/3446; G08G 1/096816; H04L 41/12; H04W 4/021; G01C 21/3453

(57) ABSTRACT

Systems and methods of pre-fetching map data are disclosed herein. In some example embodiments, a computer system determines that a network connectivity metric of a geographic area satisfies a predetermined criteria, with the network connectivity metric comprising a metric of ability of a computing device to communicate with a remote server via a network connection while the computing device is within the geographic area. The computer system causes a map data item corresponding to the geographic area to be downloaded from the remote server onto the computing device during a time at which the computing device is not located within the geographic area based on the determination that the network connectivity metric of the geographic area satisfies the predetermined criteria. The map data item is configured to be used by the computing device to display a visual representation of the geographic area on the computing device.

### TECHNICAL FIELD

Embodiments of the present disclosure relate generally to the technical field of electronic navigation devices and, more particularly, but not by way of limitation, to systems and methods of pre-fetching map data for electronic navigation devices.

### BACKGROUND

A computing device can receive data from a remote networked server via a networked connection. However, at times, the ability of a computing device to communicate with a remote networked server via a network connection may be insufficient for submitting a request for such data or for receiving such data. For example, the computing device may travel into a geographic area that has poor network coverage, thereby rendering the geographic area a dead zone for the purposes of data transmission between the computing device and the remote network server. This lack of a continuous sufficient network connection is a significant technical problem that affects the ability of computing devices to successfully perform time-sensitive functions, such as presenting information to the user of a computing device while the user of the computing device is located within a geographic area that has poor network coverage.

### BRIEF DESCRIPTION OF THE DRAWINGS

Some embodiments of the present disclosure are illustrated by way of example and not limitation in the figures of the accompanying drawings, in which like reference numbers indicate similar elements.

FIG. 1 is a block diagram of a system environment for a networked computer system, in accordance with some example embodiments.

FIG. 2 illustrates map data items displayed on a display screen of a computing device, in accordance with some example embodiments.

FIG. 3 illustrates map data items displayed on the display screen of the computing device at a higher zoom level than in FIG. 2, in accordance with some example embodiments.

FIG. 4 illustrates four different regions of a geographic area, in accordance with some example embodiments.

FIG. 5 is a flowchart illustrating a method of pre-fetching map data, in accordance with some example embodiments.

FIG. 6 is a flowchart illustrating another method of pre-fetching map data, in accordance with some example embodiments.

FIG. 7 is a flowchart illustrating yet another method of pre-fetching map data, in accordance with some example embodiments.

FIG. 8 is a flowchart illustrating a method of selecting a route, in accordance with some example embodiments.

FIG. 9 is a block diagram illustrating a mobile device, in accordance with some example embodiments.

FIG. 10 is a diagrammatic representation of a machine in the form of a computer system within which a set of instructions may be executed for causing the machine to perform any one or more of the methodologies discussed herein, according to an example embodiment.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter can be practiced without these specific details. In general, well-known instruction instances, protocols, structures, and techniques have not been shown in detail.

The present disclosure provides technical solutions for enabling a computing device to present data from a remote server to a user of a computing device even while the user of the computing device is located within a geographic area that has poor network coverage. In some example embodiments, a technical solution involves pre-fetching the data before the computing device is located within the geographic area that has poor network coverage. Additionally, other technical effects will be apparent from this disclosure as well.

In some example embodiments, operations are performed by a computer system (or other machine) having a memory and at least one hardware processor, with the operations comprising: determining that a network connectivity metric of a geographic area satisfies a predetermined criteria, the network connectivity metric comprising a metric of ability of a computing device to communicate with a remote server via a network connection while the computing device is within the geographic area; and causing a map data item corresponding to the geographic area to be downloaded from the remote server onto the computing device during a time at which the computing device is not located within the geographic area based on the determination that the network connectivity metric of the geographic area satisfies the predetermined criteria, the downloaded map data item being stored in a memory of the computing device, the map data item being configured to be used by a computing device to display a visual representation of the geographic area on the computing device.

In some example embodiments, the operations further comprise: detecting a request to display the visual representation of the geographic area on the computing device; and causing the visual representation of the geographic area to be displayed on the computing device using the map data item stored in the memory of the computing device.

In some example embodiments, the operations further comprise: determining a geolocation of a user of the computing device; and determining the geographic area based on the determined geolocation of the user, wherein the determination of the geolocation of the user and the determination of the geographic area are performed prior to any request by the computing device for navigation instructions associated with the geographic area and prior to any request by the computing device to display the visual representation of the geographic area.

In some example embodiments, the operations further comprise: receiving a request for a route from a starting geographic location to a destination geographic location; determining the route from the starting geographic location to the destination geographic location based on the request; and determining the geographic area based on the route. In some example embodiments, the determining the route comprises: generating a plurality of candidate routes from the starting geographic location to the destination geographic location; ranking the plurality of candidate routes based on a ranking model; and selecting the route based on the ranking of the plurality of candidate routes.

In some example embodiments, the network connectivity metric comprises a number of downloads that were attempted by devices and failed while the devices were located within the geographic area. In some example embodiments, the network connectivity metric comprises a number of requests received by the remote server from devices while the devices were located within the geographic area.

In some example embodiments, the map data item comprises an image file. In some example embodiments, the map data item comprises a map tile.

In some example embodiments, the computer system comprises the computing device. In some example embodiments, the computer system comprises the remote server.

In some example embodiments, the causing the map data item to be downloaded from the remote server onto the computing device is further based on at least one of: a number of road intersections in the geographic area; and a number of points of interest in the geographic area.

The methods or embodiments disclosed herein may be implemented as a computer system having one or more modules (e.g., hardware modules or software modules). Such modules may be executed by one or more hardware processors of the computer system. In some example embodiments, a non-transitory machine-readable storage device can store a set of instructions that, when executed by at least one processor, causes the at least one processor to perform the operations and method steps discussed within the present disclosure.

The details of one or more variations of the subject matter described herein are set forth in the accompanying drawings and the description below. Other features and advantages of the subject matter described herein will be apparent from the description and drawings, and from the claims.

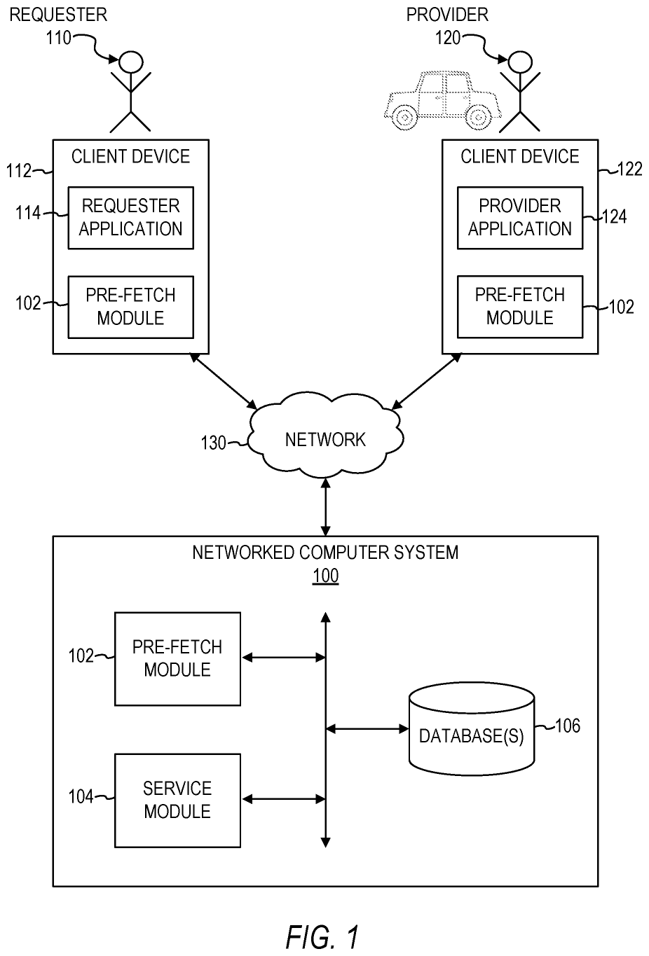

FIG. 1 is a block diagram of a system environment for a networked computer system 100, in accordance with some example embodiments. In some example embodiments, the networked computer system 100 coordinates the transportation of persons and/or goods/items for a service requester 110 (e.g., such as a rider) by a service provider 120 (e.g., a driver of a vehicle). The provider 120 uses a vehicle to provide the transportation service to the requester 110.

In some example embodiments, the networked computer system 100 comprises any combination of one or more of a pre-fetch module 102, a service module 104, and one or more databases 106. These modules and databases are not native components of a generic computer system, and provide structures and functions beyond generic functions of a computer system, as further described below.

In some example embodiments, the modules 102 and 104 and the database(s) 106 reside on a machine having a memory and at least one processor (not shown). In some example embodiments, the modules 102 and 104 and the database(s) 106 reside on the same machine, while in other example embodiments, one or more of modules 102 and 104 and database(s) 106 reside on separate remote machines that communicate with each other via a network (e.g., network 130). It is contemplated that other configurations are also within the scope of the present disclosure.

In some example embodiments, the requester 110 operates a client device 112 that executes a requester application 114 that communicates with the networked computer system 100. The requester 110 operates the requester application 114 to view information about the networked computer system 100, and to make a request for service from the networked computer system 100 for a delivery or transport service (“a trip”) of the requester 110 (and, optionally, additional persons) and/or items, for example cargo needing transport. The requester application 114 determines a pick-up location within an origin location or enables the requester 110 to specify a pick-up location and/or a destination location associated with the trip. An origin location and/or a destination location may be a location inputted by the requester 110 or may correspond to the current location of the requester client device 112 as determined automatically by a location determination module (not shown) in the requester client device 112 (e.g., a global positioning system (GPS) component), a wireless networking system, or a combination thereof. For purposes of simplicity, as described herein, an origin location can include a pick-up location for service (i) determined by the requester application 114 (e.g., based on the current location of the requester client device 112 using a GPS component), (ii) specified or selected by the requester 110, or (iii) determined by the networked computer system 100. In some embodiments, the networked computer system 100 recommends a pick-up location to a requester 110 based on historical trip data associated with the origin location.

According to examples herein, the requester client device 112 can transmit a set of data to the networked computer system 100 over a network 130 in response to requester input or operation of the requester application 114. Such data can be indicative of the requester's interest in potentially requesting service (e.g., before actually confirming or requesting the service). For example, the requester 110 may launch the requester application 114 and specify an origin location and/or a destination location to view information about the networked computer system 100 before making a decision on whether to request service. The requester 110 may want to view information about the average or estimated time of arrival for pick up by a provider 120, an estimated time to the destination, a price for the delivery or transport service, available service types, etc. Depending on implementation, the data can include the origin and/or destination location information, requester information (e.g., identifier), application information (e.g., version number), device identifier or type, etc. According to some examples, each time the requester 110 modifies the origin and/or destination location, the requester application 114 generates and transmits the data to the networked computer system 100.

The network 130 may be any network that enables communication between or among machines, databases, and devices (e.g., the networked computer system 100 and the client devices 112 and 122). Accordingly, the network 130 may be a wired network, a wireless network (e.g., a mobile or cellular network), or any suitable combination thereof. The network 130 may include one or more portions that constitute a private network, a public network (e.g., the Internet), or any suitable combination thereof. Accordingly, the network 130 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 130 may communicate information via a transmission medium. As used herein, “transmission medium” shall be taken to include any intangible medium that is capable of storing, encoding, or carrying instructions for execution by a machine, and includes digital or analog communication signals or other intangible media to facilitate communication of such software.

Once the requester 110 confirms or orders a service via the requester application 114, the requester application 114 generates data corresponding to a request for the service through the networked computer system 100 (e.g., also referred to herein as a “trip request”). Responsive to receiving the trip request, the networked computer system 100 determines the average estimated time of arrival (ETA) at the pick-up location of providers 120 whose current location is within a threshold distance of the pick-up location (e.g., providers 120 who are all within one mile of the pickup location). In some embodiments, responsive to determining that requester's ETA is within a threshold amount of time of the average ETA of nearby available providers 120, the networked computer system 100 uses information from the trip request to match the requester 110 with an available provider 120. Depending on implementation, the trip request can include requester or device information (e.g., a requester identifier, a device identifier), a service type (e.g., vehicle type) and/or selected service option (such as described herein), an origin location, a destination location, a payment profile identifier, a desired departure time, and/or other data. The networked computer system 100 selects a provider 120 from a set of providers, such as based on the provider's current location and status (e.g., offline, online, available) and/or information from the trip request (e.g., service type, origin location, and/or destination location), to provide the service for the requester and transport the requester 110 (or an item) from the origin location to the destination location. Responsive to selecting an available provider 120, the networked computer system 100 sends an invitation message to the provider client device 122 inviting the provider 120 to fulfill the trip request.

In one example embodiment, the networked computer system 100 periodically determines the requester's ETA at the pick-up location based on the topological and geospatial location of the requester client device 112. In some example embodiments, the networked computer system 100 selects the provider 120 based on a comparison of the requester's ETA and the provider's ETA at the pick-up location. For example, if the networked computer system 100 determines that the requester 110 is about three minutes away from the pick-up location, the networked computer system 100 might select a provider 120 who is also about three minutes away even if other providers 120 have a shorter ETA.

If, after matching the requester 110 with an available provider 120, the networked computer system 100 determines that the requester's ETA and the provider's ETA at the pick-up location vary by over a threshold amount of time, the networked computer system 100 can reassign the trip to another available provider 120.

The provider 120 operates the client device 122 executing a provider application 124 that communicates with the networked computer system 100 to provide information indicating whether the provider 120 is available or unavailable to provide transportation services to requesters 110. The provider application 124 can also present information about the networked computer system 100 to the provider 120, such as invitations to provide service, navigation instructions, map data, etc. In one example embodiment, the provider application 124 enables the provider 120 to provide information regarding availability of the provider 120 by logging into the networked computer system 100 and activating a setting indicating that they are currently available to provide service. The provider application 124 also provides the current location of the provider 120 or the provider client device 122 to the networked computer system 100. Depending on implementation, the current location may be a location inputted by the provider 120 or may correspond to the current location of the provider client device 122 as determined automatically by a location determination module (not shown) in the provider client device 122 (e.g., a GPS component), a wireless networking system, or a combination thereof. The provider application 124 further allows the provider 120 to receive, from the networked computer system 100, an invitation message to provide a service for the requesting requester 110, and if the provider 120 accepts via input, the provider application 124 transmits an acceptance message to the networked computer system 100. The networked computer system 100 subsequently provides information about the provider 120 to the requester application 114. In another example embodiment, the provider application 124 enables the provider 120 to view a list of current trip requests and to select a particular trip request to fulfill. The provider application 124 can also receive routing information from the networked computer system 100.

In some example embodiments, any combination of one or more of the pre-fetch module 102, the service module 104, the requester application 114, and the provider application 124 is configured to provide a variety of user interface functionality, such as generating user interfaces, interactively presenting user interfaces to the user, receiving information from the user (e.g., interactions with user interfaces), and so on. Presenting information to the user can include causing presentation of information to the user (e.g., communicating information to a device with instructions to present the information to the user). Information may be presented using a variety of means including visually displaying information and using other device outputs (e.g., audio, tactile). Similarly, information may be received via a variety of means including alphanumeric input or other device input (e.g., one or more touch screen, camera, tactile sensors, light sensors, infrared sensors, biometric sensors, microphone, gyroscope, accelerometer, other sensors). In some example embodiments, any combination of one or more of the pre-fetch module 102, the service module 104, the requester application 114, and the provider application 124 is configured to receive user input. For example, any combination of one or more of the pre-fetch module 102, the service module 104, the requester application 114, and the provider application 124 is configured to present one or more GUI elements (e.g., drop-down menu, selectable buttons, text field) with which a user can submit input.

In some example embodiments, the requester client device 112 and provider client device 122 are portable or mobile electronic devices such as smartphones, tablet devices, wearable computing devices (e.g., smartwatches) or similar devices. Alternatively, the provider client device 122 can correspond to an on-board computing system of a vehicle. Client devices typically have one or more processors, memory, touch screen displays, wireless networking system (e.g., IEEE 802.11), cellular telephony support (e.g., LTE/GSM/UMTS/CDMA/HSDP A), and location determination capabilities. The requester client device 112 and the provider client device 122 interact with the networked computer system 100 through client applications configured to interact with the networked computer system 100. The applications 114 and 124 of the requester client device 112 and the provider client device 122, respectively, can present information received from the networked computer system 100 on an interface, such as a map of the geographic region, and the current location of the requester client device 112 or the provider client device 122. The applications 114 and 124 running on the requester client device 112 and the provider client device 122 can determine the current location of their respective client device and provide the current location to the networked computer system 100.

The networked computer system 100 is configured to provide a communicative interface between the requester application 114, the provider application 124, and the various modules and databases in the networked computer system 100. The networked computer system 100 is configured to receive provider availability status information and current location information from the provider application 124 and update database(s) 106 with the availability status. The networked computer system 100 is also configured to receive trip requests from the requester application 114 and creates corresponding trip records in the database(s) 106. According to an example embodiment, a trip record corresponding to a trip request can include or be associated with a trip ID, a requester ID, an origin location, a destination location, a service type, pricing information, and/or a status indicating that the corresponding trip request has not been processed. According to one example embodiment, when the provider 120 accepts the invitation message to service the trip request for the requester 110, the trip record can be updated with the provider's information as well as the provider's location and the time when the trip request was accepted. Similarly, location and time information about the service as well as the cost for the service can be associated with the trip record.

In one example embodiment, during the trip, the networked computer system 100 receives information (e.g., periodically) from the provider application 124 indicating the location of the provider's vehicle and/or telematics information (e.g., indications of current speed, acceleration/deceleration, events, stops). The networked computer system 100 stores the information in the database(s) 106 and associates the information with the trip record. In some example embodiments, the networked computer system 100 periodically calculates the provider's ETA at the pick-up location and provides the provider's ETA to the requester application 114.

The networked computer system 100 determines the geospatial and topological location of the requester client device 112 in response to the requester 110 making a trip request through the requester application 114. In one example embodiment, the requester application 114 periodically transmits geospatial location information of the requester client device 112 to the networked computer system 100. The geospatial location information corresponds to a current location data point of the requester client device 112 at an instance in time. Such a location data point can be generated by a location determination module (not shown) in the requester client device 112 (e.g., a GPS component), a wireless networking system, or a combination thereof.

In some example embodiments, the requester application 114 and the provider application 124 are configured to display map data indicating a specific geographical location of a place, as well as navigation instructions for the requester 110 using the requester application 114 on how to navigate (e.g., walk) to the specific geographical location of the place and navigation instructions for the provider 120 using the provider application 124 on how to navigate (e.g., drive) to the specific geographical location of the place. For example, the provider application 124 may display, on the client device 122 of the provider 120, a map that includes a graphic element that corresponds to the current location of the provider 120 or the client device 122 of the provider 120 and a graphic element that corresponds to the specific geographical location of a place associated with a service request, such as a place to pick up or drop off the requester 110 associated with the service request, as well as a route from the current location of the provider 120 or the client device 122 of the provider 120 to the specific geographical location of the place associated with the service request. Similarly, the requester application 114 may display, on the client device 112 of the requester 110, a map that includes a graphic element that corresponds to the current location of the requester 110 or the client device 112 of the requester 110 and a graphic element that corresponds to the specific geographical location of the place associated with the service request, as well as a route from the current location of the requester 110 or the client device 112 of the requester 110 to the specific geographical location of the place associated with the service request.

In some example embodiments, the geographical location of a place comprises a geocode. A geocode comprises a spatial representation in numerical coordinates, such as latitude and longitude, of a physical location (e.g., a physical address). Other types of representations of a physical location may additionally or alternatively be used as the geographical location in providing the features disclosed herein.

The map data and the navigation instructions are generated based on the specific geographical location of the place associated with the service request. In some example embodiments, the corresponding map data and navigation instructions are generated by the requester application 114 and the provider application 124 using the geographical location of the place, which is received by the requester application 114 and the provider application 124 from the networked computer system 100. For example, the networked computer system 100 may store the geographical location of the place in association with an identifier of the place (e.g., a name of the place, an address of the place) in the database(s) 106, and then transmit the geographical location of the place to the requester application 114 and the provider application 124 for use in generating the corresponding map data and navigation instructions that are to be generated and displayed by the requester application 114 and the provider application 124. In other example embodiments, the corresponding map data and navigation instructions are generated by the networked computer system 100 using the geographical location of the place stored in the database(s) 108 of the networked computer system 100 in association with an identifier of the place (e.g., a name of the place, an address of the place), and then transmitted to the requester application 114 and the provider application 124 for display on client device 112 of the requester 110 and the client device 122 of the provider 120.

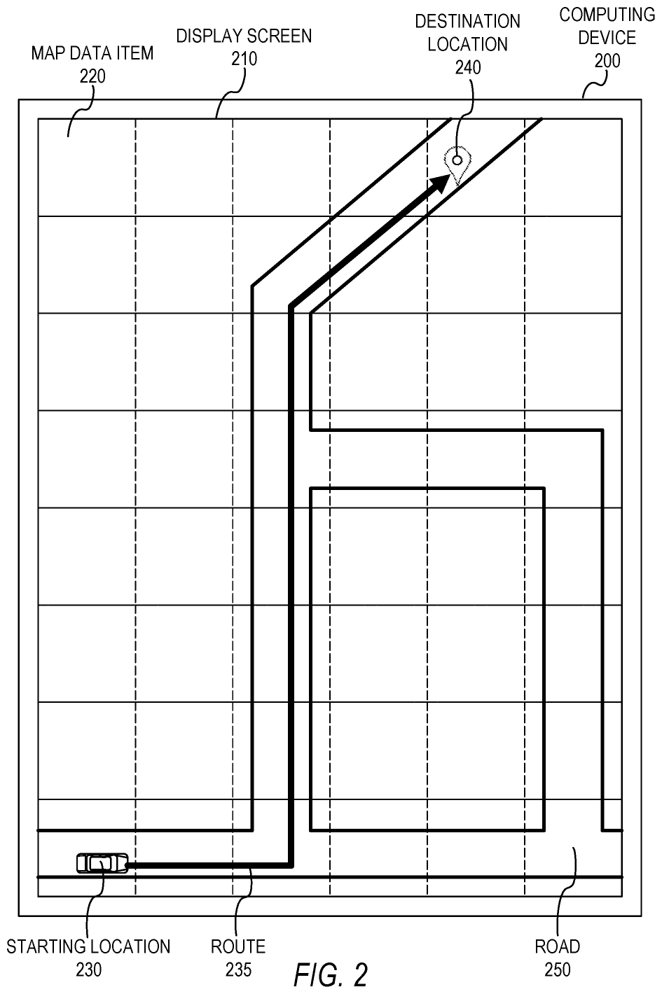

FIG. 2 illustrates map data items 220 displayed on a display screen 210 of a computing device 200, in accordance with some example embodiments. The map data items 220 comprise any data that is configured to be used by a computing device 200 to display a visual representation of a geographic area on the computing device. In some example embodiments, the map data items 220 comprise image files that together form a map, such as a tiled web map. A tiled web map is a map that is displayed in a browser by seamlessly joining several individually requested image files received over a communication network. It is contemplated that other types of map data items 220 are also within the scope of the present disclosure.

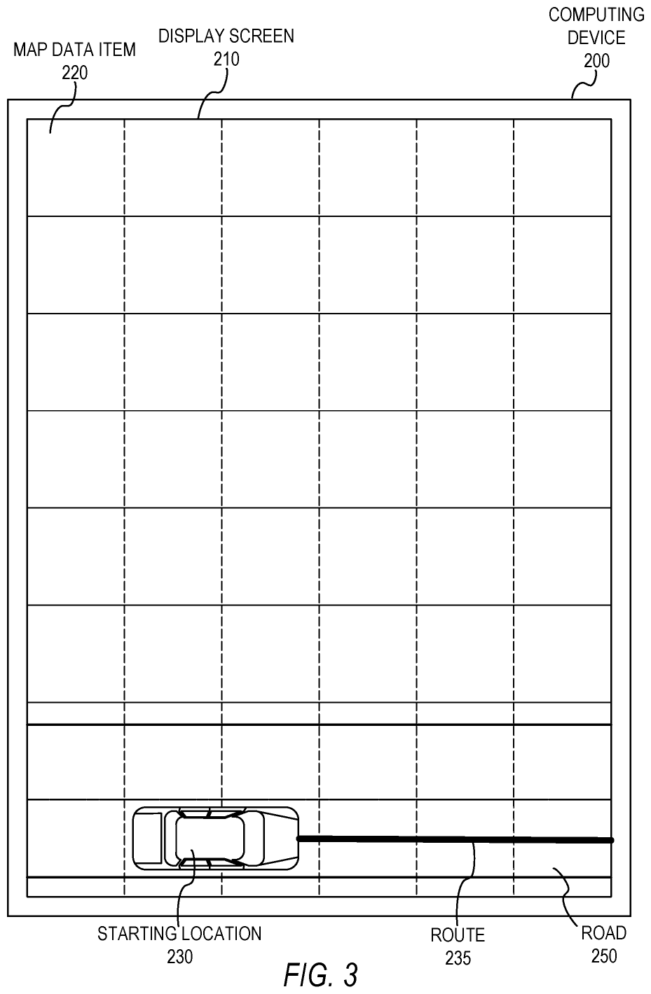

As shown in FIG. 2, in some example embodiments, the map data items 220 are displayed as part of navigation instructions from a starting geographic location 230 to a destination geographic location 240, which includes a visual representation of a route 235 from the starting geographic location 230 to the destination geographic location 240. The map data items 220 may provide details of the corresponding geographic area, such as the size, shape, and other characteristics of roads 250, as well as visual representations of other aspects and objects within the geographic area being represented. In some example embodiments, the view of the geographic area represented within the display screen 210 can be zoomed in or out, where zooming out to a lower zoom level results in a less detailed view of the geographic area being presented, and zooming in to a higher zoom level results in a more detailed view of the geographic area being presented. FIG. 3 illustrates map data items 220 displayed on the display screen 210 of the computing device 200 at a higher zoom level than in FIG. 2, in accordance with some example embodiments.

In some example embodiments, the navigation instructions are provided to a user (e.g., the requester 110 or the provider 120) as the user is traveling from the starting geographic location 230 to the destination geographic location 240, with the networked computer system 100 causing to be displayed on the computing device of the user only the map data items that correspond to locations within a particular distance from the current position of the user (e.g., the user's computing device). Often times, the user is presented with map data items 220 that represent only a limited portion of the entire geographic area that covers the route from the starting geographic location 230 to the destination geographic location 240, particularly when the user is zoomed in at a high zoom level. As the user moves, additional map data items representing geographic areas that come within the particular distance of the user due to the user's movement are displayed on the display screen of the user's computing device. However, as previously discussed, sometimes the user travels into a geographic area that has poor network coverage, thereby rendering the geographic area a dead zone for the purposes of being able to receive map data items 220 from a remote network server.

In some example embodiments, the pre-fetch module 102 is configured to determine that a network connectivity metric of a geographic area satisfies a predetermined criteria. The network connectivity metric comprises a metric of ability of a computing device (e.g., the requester client device 112, the provider client device 122) to communicate with a remote server (e.g., the networked computer system 100) via a network connection while the computing device is within the geographic area. In some example embodiments, the network connectivity metric comprises a number of downloads that were attempted by devices and failed while the devices were located within the geographic area. For example, for each geographic area, the networked computer system 100 records each instance in which a download was attempted by a user computing device and failed while the user computing device was located within the geographic area, and then the pre-fetch module 102 determines, for each geographic area, whether the total number of failed download attempts meets a particular threshold that represents poor connectivity (e.g., the total failed download attempts is above a particular threshold).

In some example embodiments, the network connectivity metric comprises a percentage of downloads that were attempted by devices and failed while the devices were located within the geographic area. For example, for each geographic area, the networked computer system 100 records each instance in which a download was attempted by a user computing device and the number of those attempts that failed while the user computing device was located within the geographic area, and then the pre-fetch module 102 determines, for each geographic area, whether the percentage of failed download attempts meets a particular threshold that represents poor connectivity (e.g., the failed download percentage is above a particular threshold).

In some example embodiments, the network connectivity metric comprises a percentage of downloads that were attempted by devices and succeeded while the devices were located within the geographic area. For example, for each geographic area, the networked computer system 100 records each instance in which a download was attempted by a user computing device and the number of those attempts that succeeded while the user computing device was located within the geographic area, and then the pre-fetch module 102 determines, for each geographic area, whether the percentage of successful download attempts meets a particular threshold that represents poor connectivity (e.g., the successful download percentage is below a particular threshold).

In some example embodiments, the network connectivity metric comprises a number of requests received by the remote server from devices while the devices were located within the geographic area. For example, for each geographic area, the networked computer system 100 records each instance in which a request was received by the remote server from any user computing device while the user computing device was located within the geographic area, and then the pre-fetch module 102 determines, for each geographic area, whether the total number of received requests meets a particular threshold that represents poor connectivity (e.g., the total received requests is below a particular threshold).

It is contemplated that other types of network connectivity metrics are also within the scope of the present disclosure and may be used by the pre-fetch module 102. In some example embodiments, the network connectivity metric comprises any combination of one or more network connectivity metrics.

In some example embodiments, the pre-fetch module 102 is configured to cause at least one map data item corresponding to the geographic area to be downloaded from the remote server onto a computing device based on the determination that the network connectivity metric of the geographic area satisfies the predetermined criteria. The downloaded map data item may be stored in a memory of the computing device.

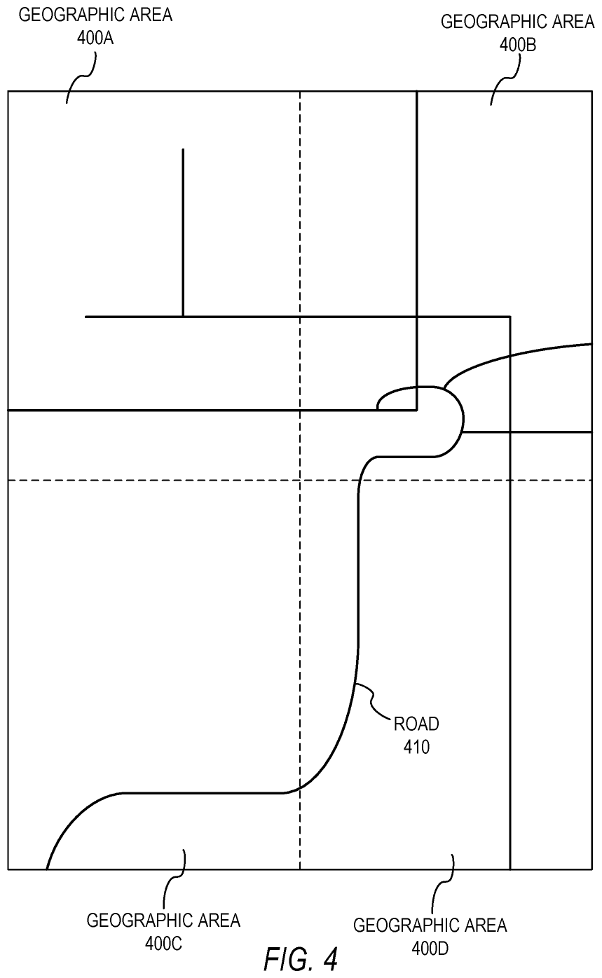

FIG. 4 illustrates four different geographic areas 400A, 400B, 400C, and 400D, in accordance with some example embodiments. FIG. 4 shows roads 410 that are within the four different geographic areas.

In some example embodiments, the pre-fetch module 102 is configured to, based on the determination that the network connectivity metric of the geographic area satisfies the predetermined criteria, cause the map data item(s) corresponding to the geographic area to be downloaded from the remote server onto the computing device during a time at which the computing device is not located within the geographic area. For example, referring to FIG. 4, the pre-fetch module 102 may cause one or more map data items corresponding to geographic area 400D to be downloaded onto the computing device during a time at which the computing device is located in geographic area 400C.

In some example embodiments, the pre-fetch module 102 is configured to, based on the determination that the network connectivity metric of the geographic area satisfies the predetermined criteria, cause the map data item(s) corresponding to the geographic area to be downloaded from the remote server onto the computing device during a time at which a request has not yet been made to use the map data item(s) to display a visual representation of the geographic area on the computing device. For example, referring to FIG. 4, the pre-fetch module 102 causes one or more map data items corresponding to geographic area 400B to be downloaded onto the computing device during a time at which the computing device is located in geographic area 400C and a request has been made to use map data items corresponding to geographic area 400D that are within a particular distance of the computing device to display a visual representation of the geographic area 400D, but also at which no request has been made to use map data items corresponding to geographic area 400B that are not within the particular distance of the computing device to display a visual representation of the geographic area 400B.

In some example embodiments, the service module 104 is configured to detect a request to display the visual representation of the geographic area on the computing device, and then cause the visual representation of the geographic area to be displayed on the computing device using the map data item stored in the memory of the computing device. The request is issued from the computing device or from a remote server based on a detection of the computing device being within a particular distance of the geographic area or the geographic area falling within the geographic view displayed on the display screen of the computing device (e.g., when the zoom level is decreased to show more geographic territory).

In some example embodiments, the pre-fetch module 102 is configured to both determine that a network connectivity metric of a geographic area satisfies a predetermined criteria and cause a map data item corresponding to the geographic area to be downloaded from the networked computer system 100 onto the computing device before the computing device transmits any request for service or navigation instructions to the networked computer system 100, such as before the computing device submits any trip request to the networked computer system 100. For example, the pre-fetch module 102 may perform these pre-fetch operations in response to an application being installed on the computing device, such as in response to the requester application 114 being installed on the client device 112 of the requester 110, in response to the requester application 114 being opened for the first time after installation on the client device 112 of the requester 110, in response to the provider application 124 being installed on the client device 122 of the provider 120, or in response to the provider application 124 being opened for the first time after installation on the client device 122 of the provider 120.

In some example embodiments, the pre-fetch module 102 is configured to determine a geolocation of a user of a computing device, such as based on GPS data or on registration information explicitly entered by the user. The pre-fetch module 102 may determine one or more geographic areas based on the determined geolocation of the user, and then determine a network connectivity metric for the geographic area(s) and determine whether the determined geographic area and/or the determined network connectivity metric satisfy the predetermined criteria, as previously discussed. In some example embodiments, the determination of the geolocation of the user and the determination of the geographic area are performed prior to any request by the computing device for navigation instructions associated with the geographic area and prior to any request by the computing device to display the visual representation of the geographic area.

In some example embodiments, the pre-fetch module 102 is configured to both determine that a network connectivity metric of a geographic area satisfies a predetermined criteria and cause a map data item corresponding to the geographic area to be downloaded from the networked computer system 100 onto the computing device after the computing device transmits a request for service or navigation instructions to the networked computer system 100. For example, the service module 104 receives a request for a route from a starting geographic location to a destination geographic location, determines the route from the starting geographic location to the destination geographic location based on the request, and then determines one or more geographic areas based on the route. The pre-fetch module 102 then determines a network connectivity metric for the geographic area(s) and determines whether they satisfy the predetermined criteria, as previously discussed.

In some example embodiments, the service module 104 is configured to determine the route by generating a plurality of candidate routes from the starting geographic location to the destination geographic location, ranking the plurality of candidate routes based on a ranking model, and then selecting the route based on the ranking of the plurality of candidate routes. For example, the service module 104 may rank the routes based on a prediction of corresponding travel times from the starting geographic location to the destination geographic location using the routes, with priority being given to the routes with the shorter travel times (e.g., the route with the shortest travel time ranked first, the route with the second shortest travel time ranked second, and so on and so forth). It is contemplated that the route may be determined in other ways as well.

In some example embodiments, the pre-fetch module 102 is configured to both determine that a network connectivity metric of a geographic area satisfies a predetermined criteria and cause a map data item corresponding to the geographic area to be downloaded from the networked computer system 100 onto the computing device as the computing device approaches the geographic area and comes within a predetermined distance of the geographic area. For example, the pre-fetch module 102 may use a shifting window of the computing device's location (e.g., 10 miles from the computing device's location) to determine whether the shifting window is extending into a red zone of poor connectivity, and then pre-fetch one or more map tiles of the geographic area if it is determined that the shifting window does extend into the red zone of poor connectivity.

In some example embodiments, the pre-fetch module 102 is configured to cause the map data item to be downloaded from the remote server onto the computing device based on one or more additional or alternative factors to the network connectivity metric. For example, the pre-fetch module 102 may be configured to cause the map data item to be downloaded from the remote server onto the computing device based on a level of complexity of the roads in the geographic area. Examples of the level of complexity of the roads in the geographic area include, but are not limited to, a number of road intersections in the geographic area (e.g., the more intersections there are, the more complex the roads are) and a degree of change in the shape of the roads in the geographic area (e.g., the more the shape of the roads change, such as with sharp curves in the road, the more complex the roads are). In one example using the geographic regions 400 and roads 410 in FIG. 4, the pre-fetch module 102 may pre-fetch one or more map data items for the geographic area 400B based on the large number of intersections and large degree of change in the shape of the roads in the geographic area 400B, even though it has good network coverage.

Another factor may be a number of points of interest in the geographic area. For example, the more businesses or other points of interest that are located in the geographic area, the more weight the pre-fetch module 102 may assign to that geographic area in determining whether to pre-fetch any map data items for the geographic area. In some example embodiments, the pre-fetch module 102 personalizes such a consideration for the specific user by accessing trip data to determine what types of points of interests the user has previously traveled to and assigns more weight to geographic areas with those types of points of interest. For example, if the user has a history of going to coffee shops, then the pre-fetch module 102 may assign additional weight to geographic areas that include a coffee shop.

In some example embodiments, the pre-fetch module 102 is configured to generate a pre-fetch plan based on one or more of the factors discussed above (e.g., poor connectivity, high level of road complexity, points of interests). The pre-fetch plan may comprise a prioritization of map data items to pre-fetch for a route. The pre-fetch module 102 then uses this prioritization to determine what map data items to pre-fetch at any given time based on the available technical capacity (e.g., bandwidth, load capacity). The pre-fetch plan may be used by the pre-fetch module 102 to intelligently balance which requests for map data items are submitted at the beginning of a route, so that the work for the current view can be performed, while at the same time preparing for upcoming potential dead zones for connectivity.

The pre-fetch module 102 may personalize the pre-fetch of map data items based on a user's tendencies. For example, if a user typically avoids highways, then the pre-fetch module 102 may pre-fetch map data items for a route that avoids highways, even though the fastest route involves a highway. The pre-fetch module 102 may also use the history of other users (e.g., trip data) to see where other users deviated from a route, and may use this information, along with other signals, such as current or predicted traffic, to determine which map data items to pre-fetch.

In some example embodiments, the pre-fetch module 102 can be used specifically to pre-fetch one or more maps data items for end points of a route. For example, if a requester is being transported to restaurant, once the user is finished at the restaurant, the requester might want to have a map of his or her current location. Since the restaurant may be located in a region of poor connectivity, the pre-fetch module 102 may pre-fetch more zoom levels of map data items covering the location of the restaurant and store those on the computing device of the user so that the user has access to those map data items when leaving the restaurant.

In some example embodiments, the pre-fetch module 102 is configured to pre-fetch map data items based on the top N places (e.g., top 10 places) that people go within a certain distance of the user's current location. In some example embodiments, the pre-fetch module 102 uses the speed of the computing device (e.g., the driving speed of the provider) to determine prioritization of pre-fetching map data items.

In some example embodiments, the pre-fetch module 102 pre-fetches map data items based on where people park for a particular destination, not just for the destination itself. For example, the pre-fetch module 102 may determine that a threshold number of users park in a parking lot three blocks away from a particular destination, and then pre-fetch one or more map data items covering that parking lot when a user is traveling to that destination.

Although FIG. 1 shows the pre-fetch module 102 as part of a networked computer system 100 that is acting as a server in a client-server relationship with client devices 112 and 122, in some example embodiments, the pre-fetch module 102 or any combination of the components of the networked computer system 100 reside on one or more of the client devices 112 and 122, either being integrated into the requester application 114 and/or the provider application 124 or being installed on one or more of the client devices 112 and 122 as a separate component from the requester application 114 and/or the provider application 124.

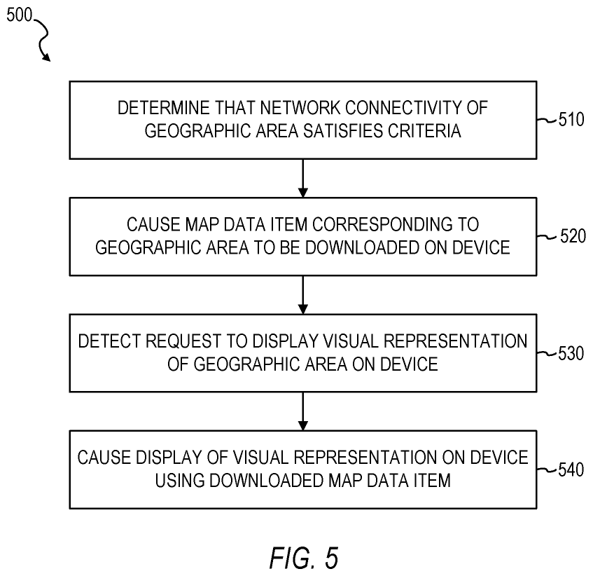

FIG. 5 is a flowchart illustrating a method 500 of pre-fetching map data, in accordance with some example embodiments. The method 500 can be performed by processing logic that comprises hardware (e.g., circuitry, dedicated logic, programmable logic, microcode), software (e.g., instructions run on a processing device), or a combination thereof. In one example embodiment, the method 500 is performed by the networked computer system 100 of FIG. 1 or any combination of one or more of its components or modules (e.g., pre-fetch module 102, service module 104), as described above.

At operation 510, the networked computer system 100 determines that a network connectivity metric of a geographic area satisfies a predetermined criteria. In some example embodiments, the network connectivity metric comprises a metric of ability of a computing device to communicate with a remote server via a network connection while the computing device is within the geographic area. In some example embodiments, the network connectivity metric comprises a number of downloads that were attempted by devices and failed while the devices were located within the geographic area. In some example embodiments, the network connectivity metric comprises a number of requests received by the remote server from devices while the devices were located within the geographic area.

At operation 520, the networked computer system 100 causes a map data item corresponding to the geographic area to be downloaded from the remote server onto the computing device during a time at which the computing device is not located within the geographic area based on the determination that the network connectivity metric of the geographic area satisfies the predetermined criteria. In some example embodiments, the downloaded map data item is stored in a memory of the computing device, and the map data item is configured to be used by a computing device to display a visual representation of the geographic area on the computing device. In some example embodiments, the map data item comprises an image file. In some example embodiments, the map data item comprises a map tile. In some example embodiments, the causing the map data item to be downloaded from the remote server onto the computing device is further based on at least one of a number of road intersections in the geographic area and a number of points of interest in the geographic area.

At operation 530, the networked computer system 100 detects a request to display the visual representation of the geographic area on the computing device. At operation 540, the networked computer system 100 causes the visual representation of the geographic area to be displayed on the computing device using the map data item stored in the memory of the computing device. In some example embodiments, the computer system comprises the computing device. In some example embodiments, the computer system comprises the remote server.

It is contemplated that any of the other features described within the present disclosure can be incorporated into the method 500.

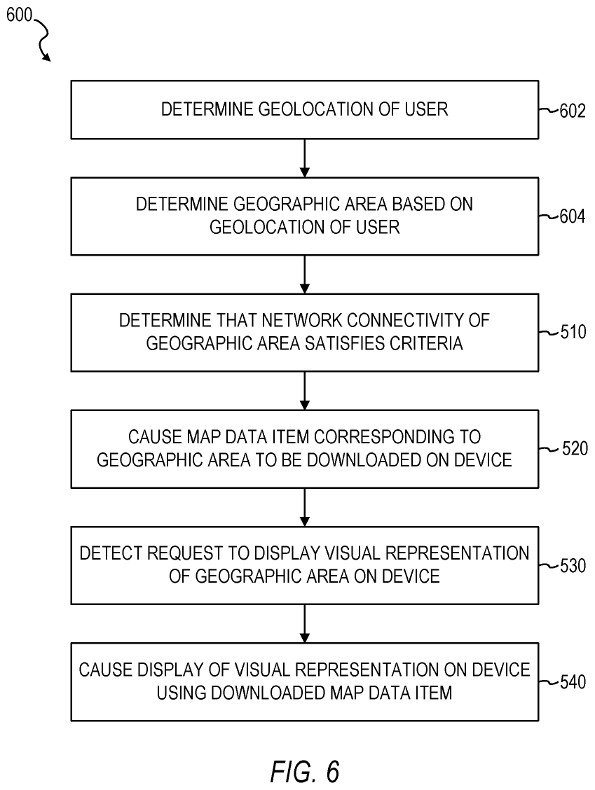

FIG. 6 is a flowchart illustrating another method 600 of pre-fetching map data, in accordance with some example embodiments. The method 600 can be performed by processing logic that comprises hardware (e.g., circuitry, dedicated logic, programmable logic, microcode), software (e.g., instructions run on a processing device), or a combination thereof. In one example embodiment, the method 600 is performed by the networked computer system 100 of FIG. 1 or any combination of one or more of its components or modules (e.g., pre-fetch module 102, service module 104), as described above. In some example embodiments, the operations of method 600 precede the operations of method 500 in FIG. 5.

At operation 602, the networked computer system 100 determines a geolocation of a user of the computing device, such as based on GPS data of the computing device or on registration information explicitly entered by the user. At operation 604, the networked computer system 100 determines the geographic area based on the determined geolocation of the user. In some example embodiments, the determination of the geolocation of the user and the determination of the geographic area are performed prior to any request by the computing device for navigation instructions associated with the geographic area and prior to any request by the computing device to display the visual representation of the geographic area.

It is contemplated that any of the other features described within the present disclosure can be incorporated into the method 600.

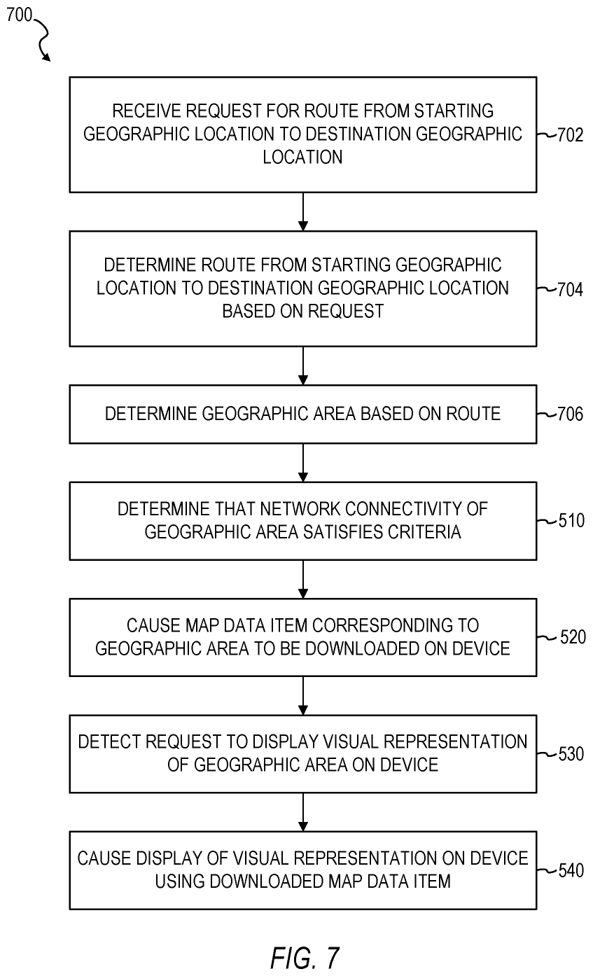

FIG. 7 is a flowchart illustrating yet another method 700 of pre-fetching map data, in accordance with some example embodiments. The method 700 can be performed by processing logic that comprises hardware (e.g., circuitry, dedicated logic, programmable logic, microcode), software (e.g., instructions run on a processing device), or a combination thereof. In one example embodiment, the method 700 is performed by the networked computer system 100 of FIG. 1 or any combination of one or more of its components or modules (e.g., pre-fetch module 102, service module 104), as described above. In some example embodiments, the operations of method 700 precede the operations of method 500 in FIG. 5.

At operation 702, the networked computer system 100 receives a request for a route from a starting geographic location to a destination geographic location. In some example embodiments, the service module 104 receives the request for the route from the client device 112 of the requester 110 or the client device 122 of the provider 120.

At operation 704, the networked computer system 100 determines the route from the starting geographic location to the destination geographic location based on the request. In some example embodiments, the service module 104 determines, in response to receiving the request, the route from the starting geographic location to the destination geographic location based on one or more factors. Examples of such factors include, but are not limited, a plurality of possible routes from the starting geographic location to the destination geographic location, a time associated with the request, past traffic conditions for the possible routes, current traffic conditions for the possible routes, predicted future traffic conditions for the possible routes, and estimated travel times for the possible routes. In some example embodiments, the service module 104 selects a route from the plurality of possible routes based on the selected route having the shortest estimated travel time. However, it is contemplated that other criteria for selecting the route may be used as well.

At operation 706, the networked computer system 100 determines the geographic area based on the route. In some example embodiments, the service module 104 determines the geographic area by determining which geographic areas the route passes through or which geographic areas are within a predetermined distance of the route (e.g., geographic areas within one mile of the route), and then selects these geographic areas for use as the geographic areas in the operations of the pre-fetch module 102 discussed above.

It is contemplated that any of the other features described within the present disclosure can be incorporated into the method 700.

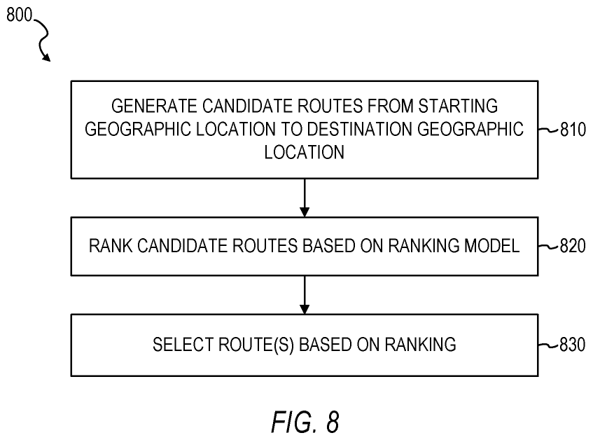

FIG. 8 is a flowchart illustrating a method 800 of selecting a route, in accordance with some example embodiments. The method 800 can be performed by processing logic that comprises hardware (e.g., circuitry, dedicated logic, programmable logic, microcode), software (e.g., instructions run on a processing device), or a combination thereof. In one example embodiment, the method 800 is performed by the networked computer system 100 of FIG. 1 or any combination of one or more of its components or modules (e.g., pre-fetch module 102, service module 104), as described above.

At operation 810, the networked computer system 100 generates a plurality of candidate routes from the starting geographic location to the destination geographic location. In some example embodiments, the service module 104 generates the plurality of candidate routes by determining possible routes from the starting geographic location to the destination geographic location based on an analysis of the roads and other travel pathways available for traveling from the starting geographic location to the destination geographic location.

At operation 820, the networked computer system 100 ranks the plurality of candidate routes based on a ranking model. In some example embodiments, the service module 104 generates scores for each one of the candidate routes using the ranking model based on one or more factors. Examples of such factors include, but are not limited, a plurality of possible routes from the starting geographic location to the destination geographic location, a time associated with the request, past traffic conditions for the possible routes, current traffic conditions for the possible routes, predicted future traffic conditions for the possible routes, and estimated travel times for the possible routes. The service module 104 then ranks the candidate routes based on their corresponding scores.

At operation 830, the networked computer system 100 selects the route based on the ranking of the plurality of candidate routes. In some example embodiments, the service module 104 selects the highest ranked candidate route.

It is contemplated that any of the other features described within the present disclosure can be incorporated into the method 800.

It is contemplated that any features of any embodiments disclosed herein can be combined with any other features of any other embodiments disclosed herein. Accordingly, these any such hybrid embodiments are within the scope of the present disclosure.

### Example Mobile Device

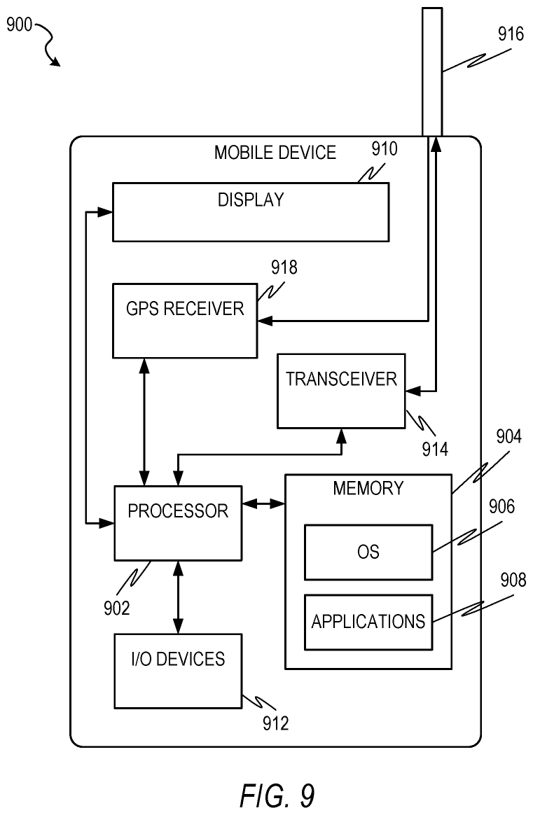

FIG. 9 is a block diagram illustrating a mobile device 900, according to an example embodiment. The mobile device 900 can include a processor 902. The processor 902 can be any of a variety of different types of commercially available processors suitable for mobile devices 900 (for example, an XScale architecture microprocessor, a Microprocessor without Interlocked Pipeline Stages (MIPS) architecture processor, or another type of processor). A memory 904, such as a random access memory (RAM), a Flash memory, or other type of memory, is typically accessible to the processor 902. The memory 904 can be adapted to store an operating system (OS) 906, as well as application programs 908, such as a mobile location-enabled application that can provide location-based services (LBSs) to a user. The processor 902 can be coupled, either directly or via appropriate intermediary hardware, to a display 910 and to one or more input/output (I/O) devices 912, such as a keypad, a touch panel sensor, a microphone, and the like. Similarly, in some embodiments, the processor 902 can be coupled to a transceiver 914 that interfaces with an antenna 916. The transceiver 914 can be configured to both transmit and receive cellular network signals, wireless data signals, or other types of signals via the antenna 916, depending on the nature of the mobile device 900. Further, in some configurations, a GPS receiver 918 can also make use of the antenna 916 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a processor configured using software, the processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

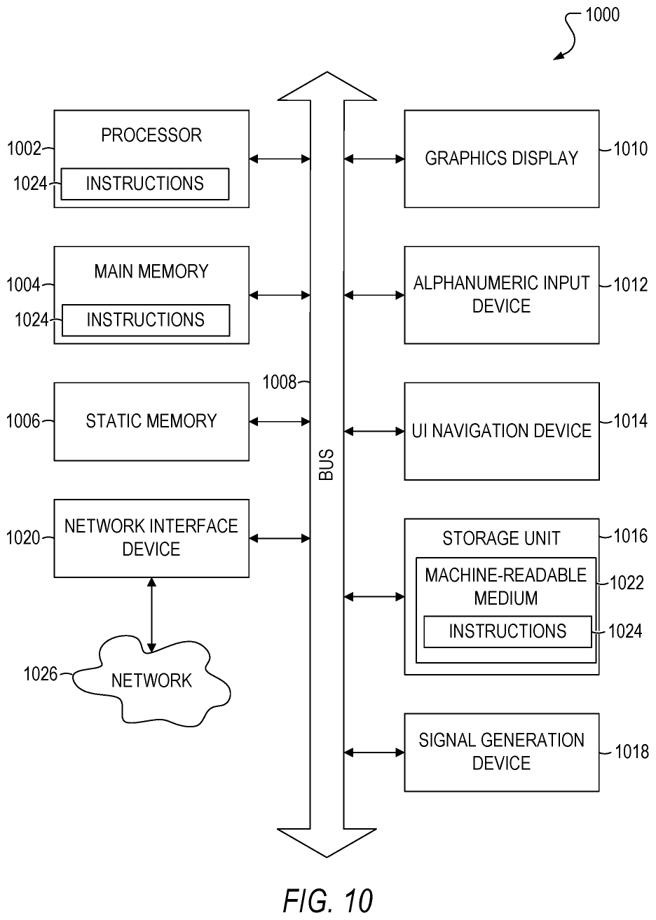

FIG. 10 is a block diagram of an example computer system 1000 on which methodologies described herein may be executed, in accordance with an example embodiment. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU) or both), a main memory 1004 and a static memory 1006, which communicate with each other via a bus 1008. The computer system 1000 may further include a graphics display unit 1010 (e.g., a liquid crystal display (LCD) or a cathode ray tube (CRT)). The computer system 1000 also includes an alphanumeric input device 1012 (e.g., a keyboard or a touch-sensitive display screen), a user interface (UI) navigation device 1014 (e.g., a mouse), a storage unit 1016, a signal generation device 1018 (e.g., a speaker) and a network interface device 1020.

### Machine-Readable Medium

The storage unit 1016 includes a machine-readable medium 1022 on which is stored one or more sets of instructions and data structures (e.g., software) 1024 embodying or utilized by any one or more of the methodologies or functions described herein. The instructions 1024 may also reside, completely or at least partially, within the main memory 1004 and/or within the processor 1002 during execution thereof by the computer system 1000, the main memory 1004 and the processor 1002 also constituting machine-readable media.

While the machine-readable medium 1022 is shown in an example embodiment to be a single medium, the term “machine-readable medium” may include a single medium or multiple media (e.g., a centralized or distributed database, and/or associated caches and servers) that store the one or more instructions 1024 or data structures. The term “machine-readable medium” shall also be taken to include any tangible medium that is capable of storing, encoding or carrying instructions (e.g., instructions 1024) for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1024 may further be transmitted or received over a communications network 1026 using a transmission medium. The instructions 1024 may be transmitted using the network interface device 1020 and any one of a number of well-known transfer protocols (e.g., HTTP). Examples of communication networks include a local area network (“LAN”), a wide area network (“WAN”), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

### Executable Instructions and Machine-Storage Medium

The various memories (i.e., 1004, 1006, and/or memory of the processor(s) 1002) and/or storage unit 1016 may store one or more sets of instructions and data structures (e.g., software) 1024 embodying or utilized by any one or more of the methodologies or functions described herein. These instructions, when executed by processor(s) 1002 cause various operations to implement the disclosed embodiments.

As used herein, the terms “machine-storage medium,” “device-storage medium,” “computer-storage medium” (referred to collectively as “machine-storage medium 1022”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 1022 include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage media, computer-storage media, and device-storage media 1022 specifically exclude carrier waves, modulated data signals, and other such media, at least some of which are covered under the term “signal medium” discussed below.

### Signal Medium

The term “signal medium” or “transmission medium” in this disclosure shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

### NUMBERED EXAMPLES OF EMBODIMENTS

The following numbered examples are embodiments.
1. A computer-implemented method comprising:
   determining, by a computer system having at least one hardware processor, that a network connectivity metric of a geographic area satisfies a predetermined criteria, the network connectivity metric comprising a metric of ability of a computing device to communicate with a remote server via a network connection while the computing device is within the geographic area; and
   causing, by the computer system, a map data item corresponding to the geographic area to be downloaded from the remote server onto the computing device during a time at which the computing device is not located within the geographic area based on the determination that the network connectivity metric of the geographic area satisfies the predetermined criteria, the downloaded map data item being stored in a memory of the computing device, the map data item being configured to be used by a computing device to display a visual representation of the geographic area on the computing device.
2. The computer-implemented method of example 1, further comprising:
   detecting, by the computer system, a request to display the visual representation of the geographic area on the computing device; and
   causing, by the computer system, the visual representation of the geographic area to be displayed on the computing device using the map data item stored in the memory of the computing device.
3. The computer-implemented method of example 1 or example 2, further comprising:
   determining, by the computer system, a geolocation of a user of the computing device; and
   determining, by the computer system, the geographic area based on the determined geolocation of the user,
   wherein the determination of the geolocation of the user and the determination of the geographic area are performed prior to any request by the computing device for navigation instructions associated with the geographic area and prior to any request by the computing device to display the visual representation of the geographic area.
4. The computer-implemented method of any one of examples 1 to 3, further comprising:
   receiving, by the computer system, a request for a route from a starting geographic location to a destination geographic location;
   determining, by the computer system, the route from the starting geographic location to the destination geographic location based on the request; and
   determining, by the computer system, the geographic area based on the route.
5. The computer-implemented method of examples 4, wherein the determining the route comprises:
   generating a plurality of candidate routes from the starting geographic location to the destination geographic location;
   ranking the plurality of candidate routes based on a ranking model; and
   selecting the route based on the ranking of the plurality of candidate routes.
6. The computer-implemented method of any one of examples 1 to 5, wherein the network connectivity metric comprises a number of downloads that were attempted by devices and failed while the devices were located within the geographic area.
7 The computer-implemented method of any one of examples 1 to 6, wherein the network connectivity metric comprises a number of requests received by the remote server from devices while the devices were located within the geographic area.
8. The computer-implemented method of any one of examples 1 to 7, wherein the map data item comprises an image file.
9. The computer-implemented method of any one of examples 1 to 8, wherein the map data item comprises a map tile.
10. The computer-implemented method of any one of examples 1 to 9, wherein the computer system comprises the computing device.
11. The computer-implemented method of any one of examples 1 to claim 9, wherein the computer system comprises the remote server.
12. The computer-implemented method of any one of examples 1 to 11, wherein the causing the map data item to be downloaded from the remote server onto the computing device is further based on at least one of:
   a number of road intersections in the geographic area; and
   a number of points of interest in the geographic area.
13. A system comprising:
   at least one hardware processor; and
   a machine-readable medium embodying a set of instructions that, when executed by the at least one hardware processor, cause the at least one hardware processor to perform the method of any one of examples 1 to 12.
14. A machine-readable medium embodying a set of instructions that, when executed by the at least one hardware processor, cause the at least one hardware processor to perform the method of any one of examples 1 to 12.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
determining, by a computer system having at least one hardware processor, that a network connectivity metric of a geographic area satisfies a predetermined criteria, the network connectivity metric comprising a metric of ability of a computing device to communicate with a remote server via a network connection while the computing device is within the geographic area; and
causing, by the computer system, a map data item corresponding to the geographic area to be downloaded from the remote server onto the computing device during a time at which the computing device is not located within the geographic area based on the determination that the network connectivity metric of the geographic area satisfies the predetermined criteria, the downloaded map data item being stored in a memory of the computing device, the map data item being configured to be used by the computing device to display a visual representation of the geographic area on the computing device.

2. The computer-implemented method of claim 1, further comprising:
detecting, by the computer system, a request to display the visual representation of the geographic area on the computing device; and
causing, by the computer system, the visual representation of the geographic area to be displayed on the computing device using the map data item stored in the memory of the computing device.

3. The computer-implemented method of claim 1, further comprising:
determining, by the computer system, a geolocation of a user of the computing device; and
determining, by the computer system, the geographic area based on the determined geolocation of the user,
wherein the determination of the geolocation of the user and the determination of the geographic area are performed prior to any request by the computing device for navigation instructions associated with the geographic area and prior to any request by the computing device to display the visual representation of the geographic area.

4. The computer-implemented method of claim 1, further comprising:
receiving, by the computer system, a request for a route from a starting geographic location to a destination geographic location;
determining, by the computer system, the route from the starting geographic location to the destination geographic location based on the request; and
determining, by the computer system, the geographic area based on the route.

5. The computer-implemented method of claim 4, wherein the determining the route comprises:
generating a plurality of candidate routes from the starting geographic location to the destination geographic location;
ranking the plurality of candidate routes based on a ranking model; and
selecting the route based on the ranking of the plurality of candidate routes.

6. The computer-implemented method of claim 1, wherein the network connectivity metric comprises a number of downloads that were attempted by devices and failed while the devices were located within the geographic area.

7. The computer-implemented method of claim 1, wherein the network connectivity metric comprises a number of requests received by the remote server from devices while the devices were located within the geographic area.

8. The computer-implemented method of claim 1, wherein the map data item comprises an image file.

9. The computer-implemented method of claim 1, wherein the map data item comprises a map tile.

10. The computer-implemented method of claim 1, wherein the computer system comprises the computing device.

11. The computer-implemented method of claim 1, wherein the computer system comprises the remote server.

12. The computer-implemented method of claim 1, wherein the causing the map data item to be downloaded from the remote server onto the computing device is further based on at least one of:
a number of road intersections in the geographic area; and
a number of points of interest in the geographic area.

13. A system comprising:
at least one hardware processor; and
a machine storage medium embodying a set of instructions that, when executed by the at least one hardware processor, cause the at least one processor to perform operations comprising:
determining that a network connectivity metric of a geographic area satisfies a predetermined criteria, the network connectivity metric comprising a metric of ability of a computing device to communicate with a remote server via a network connection while the computing device is within the geographic area; and
causing a map data item corresponding to the geographic area to be downloaded from the remote server onto the computing device during a time at which the computing device is not located within the geographic area based on the determination that the network connectivity metric of the geographic area satisfies the predetermined criteria, the downloaded map data item being stored in a memory of the computing device, the map data item being configured to be used by the computing device to display a visual representation of the geographic area on the computing device.

14. The system of claim 13, wherein the operations further comprise:
detecting a request to display the visual representation of the geographic area on the computing device; and
causing the visual representation of the geographic area to be displayed on the computing device using the map data item stored in the memory of the computing device.

15. The system of claim 13, wherein the operations further comprise:
determining a geolocation of a user of the computing device; and
determining the geographic area based on the determined geolocation of the user,
wherein the determination of the geolocation of the user and the determination of the geographic area are performed prior to any request by the computing device for navigation instructions associated with the geographic area and prior to any request by the computing device to display the visual representation of the geographic area.

16. The system of claim 13, wherein the operations further comprise:
receiving a request for a route from a starting geographic location to a destination geographic location;
determining the route from the starting geographic location to the destination geographic location based on the request; and
determining the geographic area based on the route.

17. The system of claim 16, wherein the determining the route comprises:
generating a plurality of candidate routes from the starting geographic location to the destination geographic location;
ranking the plurality of candidate routes based on a ranking model; and
selecting the route based on the ranking of the plurality of candidate routes.

18. The system of claim 13, wherein the network connectivity metric comprises a number of downloads that were attempted by devices and failed while the devices were located within the geographic area.

19. The system of claim 13, wherein the network connectivity metric comprises a number of requests received by the remote server from devices while the devices were located within the geographic area.

20. A machine storage medium embodying a set of instructions that, when executed by at least one hardware processor, cause the processor to perform operations comprising:
determining that a network connectivity metric of a geographic area satisfies a predetermined criteria, the network connectivity metric comprising a metric of ability of a computing device to communicate with a remote server via a network connection while the computing device is within the geographic area; and
causing a map data item corresponding to the geographic area to be downloaded from the remote server onto the computing device during a time at which the computing device is not located within the geographic area based on the determination that the network connectivity metric of the geographic area satisfies the predetermined criteria, the downloaded map data item being stored in a memory of the computing device, the map data item being configured to be used by the computing device to display a visual representation of the geographic area on the computing device.
